(19) United States
(12) Patent Application Publication
(10) Pub. No.: US 2006/0087832 A1
(43) Pub. Date: Apr. 27, 2006

(54) Illuminating textile device

(76) Inventors: Chi-Tsung Peng, Hsinchu City (TW); Chien-Tang Wang, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/038,127

(22) Filed: Jan. 21, 2005

(30) Foreign Application Priority Data
Oct. 22, 2004 (TW) 93132228

(51) Int. Cl. F21V 21/08

(52) U.S. Cl. 362/103

(57) ABSTRACT

The present invention relates to an illuminating textile device. The illuminating textile device has a pattern layer and an optical fabric layer. The pattern layer has a transparent area and a non-transparent area. The optical fabric layer is woven from fiber optics and threads for providing the light source. The optical fabric layer is attached to the pattern layer by sewing or a fixation component.

### RELATED APPLICATIONS

The present application is based on, and claims priority from, Taiwan Application Serial Number 93132228, filed Oct. 22, 2004, the disclosure of which is hereby incorporated by reference herein in its entirety.

### BACKGROUND

1. Field of Invention

The present invention relates to an illuminating textile device. More particularly, the present invention relates to an illuminating textile device utilizing an optical fabric layer as a light source.

2. Description of Related Art

Conventionally, illuminating devices can be classified into two categories. One type is a passive reflective illuminating device, which illuminates by reflecting light from other external light sources. Light from the external light sources is reflected by reflective material coated on the passive reflective illuminating device. However, for the passive reflective illuminating devices, the illumination intensity is mainly determined by the light of other external light sources. If the light intensity of other external light sources is insufficient, the illumination intensity of the passive reflective illuminating devices also diminishes.

The other type is an active illuminating device, which is illuminated by an internal light source, such as a LED. However, for the active illuminating devices, the illumination area is often limited to a small portion of the active illuminating device. An active illumination device with large illumination area is often unavailable and difficult to manufacture.

### SUMMARY

It is therefore an objective of the present invention to provide an illuminating textile device with enhanced illumination intensity, sustained lifetime, and increased illumination area.

In accordance with the foregoing and other objectives of the present invention, an illuminating textile device is provided. The illuminating textile device comprises a pattern layer and an optical fabric layer. The pattern layer comprises a transparent area and a non-transparent area to form the pattern to be displayed. The optical fabric layer is woven from fiber optics and threads for providing the light source. The optical fabric layer is attached to the pattern layer by sewing or a fixation component.

The illuminating textile device according to the present invention has a sustained lifetime, increased illumination area, low power consumption, and high luminance. The illuminating device according to the present invention can be mass produced, and employed in various applications, such as clothes, bags, kites, tents, hats, belts, toys or decorations. Further, the illuminating textile device according to the present invention has the advantage of easy replacement. The user can replace the pattern layer with desired patterns conveniently and easily.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1A is a diagram illustrating the arrangement of fiber optics and threads of the optical fabric layer according to the present invention, where the fiber optics are horizontally arranged, and the threads are vertically arranged;

FIG. 1B is a diagram illustrating the arrangement of fiber optics and threads of the optical fabric layer according to the present invention, where the fiber optics and threads are horizontally arranged, and the threads are vertically arranged;

FIG. 1C is a diagram illustrating the arrangement of fiber optics and threads of the optical fabric layer according to the present invention, where the fiber optics and threads are horizontally arranged, and the threads are vertically arranged;

FIG. 2A is a front view diagram of the illuminating textile device according to the first preferred embodiment of the present invention;

FIG. 2B is an assembly diagram of the illuminating textile device according to the first preferred embodiment of the present invention;

FIG. 3 is an assembly diagram of the illuminating textile device according to the second preferred embodiment of the present invention;

FIG. 4A is a top view diagram of the illuminating textile device according to the third preferred embodiment of the present invention; and

FIG. 4B is an assembly diagram of the illuminating textile device according to the third preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The present invention provides an active illuminating textile device utilizing an optical fabric layer as a light source. Compared with the conventional active illuminating devices, the illuminating textile device according to the present invention has the advantages of a longer lifetime, lower power consumption, decreased volume, and increased illumination area. The illumination textile device according to the present invention can be employed in clothes, vests, or raincoats. The illuminating textile device according to the present invention can also be applied for entertainment in devices such as decorations, toys, kites or dolls.

The illuminating textile device according to the present invention comprises a pattern layer and an optical fabric layer. The pattern layer comprises a transparent area and a non-transparent area. By appropriately arranging the transparent area and the non-transparent area, a pattern to be displayed can be formed. The pattern layer can be made of cloth when the illuminating textile device according to the present invention is employed in clothes. The pattern layer can be made of plastic when the illuminating textile device according to the present invention is applied to toys or decorations.

The optical fabric layer is woven from fiber optics and threads. The threads can be reflective yarn or transparent yarn. The optical fabric layer woven from fiber optics and threads has improved illumination intensity due to the enhanced reflection from the reflective yarn or transparent yarn. Further, compared with the illuminating device merely employing fiber optics, the optical fabric layer can magnify and homogenize the light emitted by the fiber optics. Furthermore, the optical fabric layer can be woven from the conventional weaving machine, and mass production becomes feasible.

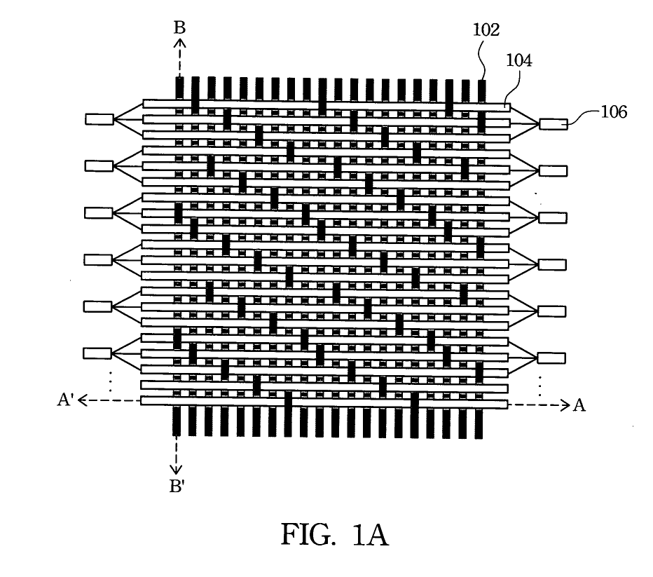

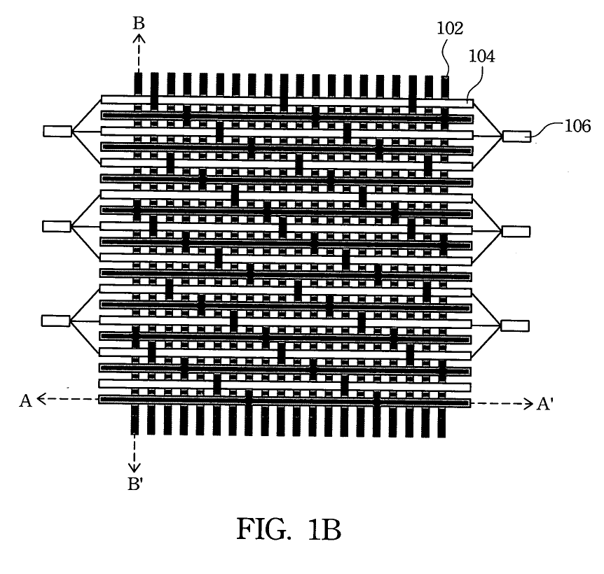

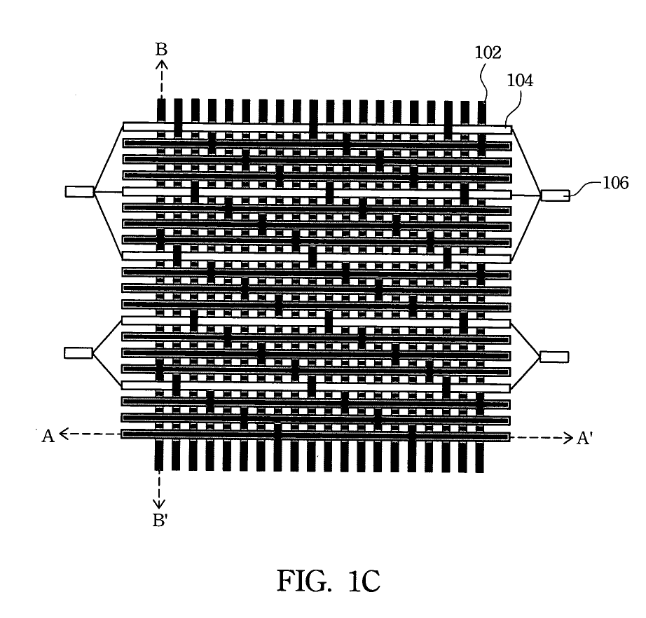

The optical fabric layer can be woven from fiber optics and threads with different arrangements. FIG. 1A to FIG. 1C demonstrates different arrangements of the fiber optics and the threads of the optical fabric layer. As shown in FIG. 1A, the arrowheads from A to A′ represent a horizontal direction, while the arrowheads from B to B′ represent a vertical direction. In the horizontal direction, the optical fabric layer is purely comprised of the fiber optics 104, while in the vertical direction, the optical fabric layer is purely comprised of the threads 102. Several fiber optics 104 merge into a bundle 106, and LEDs are provided in the bundle as a light source for the fiber optics. Further, the optical fabric layer can be powered by an AC source or a battery module, such as a dry battery or a solar battery.

Furthermore, the threads 102 and the fiber optics 104 can be arranged in an alternating pattern. As shown in FIG. 1B, in the horizontal direction, the optical fabric layer is comprised of both threads 102 and the fiber optics 104, and each thread 102 is adjacent to the fiber optic 104. In the vertical direction, the optical fabric layer is comprised solely of threads. Similarly, several fiber optics 104 merge into a bundle 106. Furthermore, as shown in FIG. 1C, in the horizontal direction, the optical fabric layer is also comprised of the threads 102 and the fiber optics 104, but each thread 102 is adjacent to more than one fiber optics 104. Various arrangements can be adapted to create different display effects. For example, when the proportion of the fiber optics increases, the illumination intensity of the optical fabric layer also increases.

The optical fabric layer can be sewed on the pattern layer. Alternatively, the optical fabric layer can be attached to the pattern layer by a first fixation component. The first fixation component is an easily detached fixation component, such as a button or Velcro. When a button or Velcro is utilized for attaching the optical fabric layer to the pattern layer, the pattern layer can be detached and replaced conveniently and easily when the user would like to replace the pattern layer with different patterns. For example, when the illuminating textile device according to the present invention is employed in clothing decoration, the pattern layer can be detached from the optical fabric layer for cleaning. Alternatively, the user can also replace the pattern layer with desired patterns.

Furthermore, a transparent layer is provided for homogenizing the light emitted by the optical fabric layer, and for protecting the optical fabric layer from damage. The transparent layer can be made of a transparent film. The transparent layer can be placed between the pattern layer and the optical fabric layer. Alternatively, the transparent layer can be placed on the pattern layer such that the pattern layer is between the transparent layer and the optical fabric layer. The transparent layer can be sewed on the pattern layer or the optical fabric layer, or a second fixation component, such as a button or Velcro, can be employed for attaching the transparent layer to the pattern layer or the optical fabric layer.

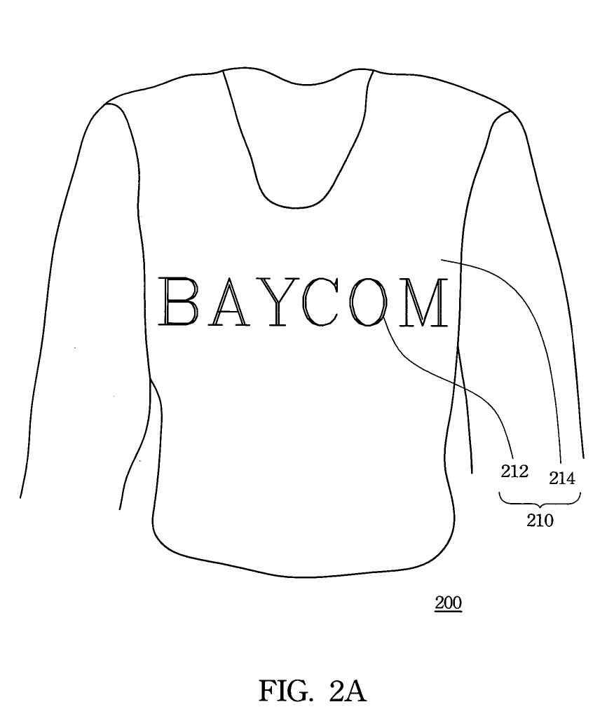

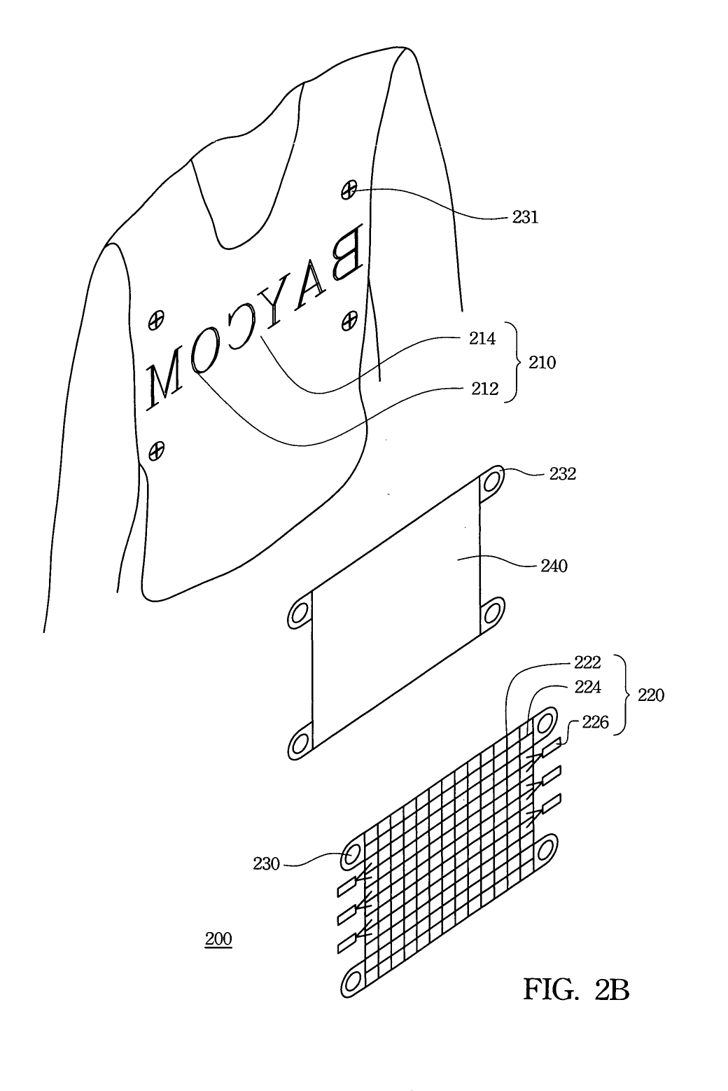

FIG. 2A and FIG. 2B illustrate an illuminating textile device according to the first preferred embodiment of the present invention. The illuminating textile device according to the first embodiment of the present invention is employed in clothes. FIG. 2A is a front view diagram of the illuminating clothes 200 according to the first preferred embodiment of the present invention. The pattern layer 210 is a portion of the clothes, and comprises a transparent area 212 and a non-transparent area 214. The light emitted through the transparent area 212 can achieve the illumination result.

FIG. 2B is an assembly diagram of the illuminating clothes 200. The illuminating clothes 200 comprise a pattern layer 210 and an optical fabric layer 220. The pattern layer 210 is a portion of the clothes 200, and comprises the transparent area 212 and the non-transparent area 214 to from the pattern to be displayed. The light generated by the optical fabric layer 240 is emitted through the transparent area 212 for achieving the illumination effect.

The optical fabric layer 220 is woven from threads 222 and fiber optics 224. Several fiber optics 224 merge into a bundle 226, and LEDs in the bundle 226 supply light to the fiber optics 224. The bundle 226 is further connected to a switch and an AC source or a battery module, such as a dry battery or a solar battery. The optical fabric layer 220 can be attached to a corresponding attaching component 231 of the pattern layer 210 by a first fixation component 230, such as a button or Velcro.

Moreover, a transparent layer 240 is provided for homogenizing the light emitted by the optical fabric layer 220, and for protecting the optical fabric layer 220 from damage. For example, the transparent layer 240 is a transparent film and placed between the pattern layer 210 and the optical fabric layer 220. A second fixation component 232 is employed for attaching the transparent layer 240 to the pattern layer 210 or the optical fabric layer 220. The second fixation component 232 can be a button or Velcro.

Since the optical fabric layer 220 is vulnerable during cleaning, the user can detach the pattern layer 210 from the optical fabric layer 220 conveniently by the first fixation component 230 when the pattern layer 210 needs cleaning. By this design, damage to the optical fabric layer 220 during cleaning can be avoided. Furthermore, the user also can easily replace the pattern layer 210 with different patterns or colors by the first fixation component 230 if other display effects are desired.

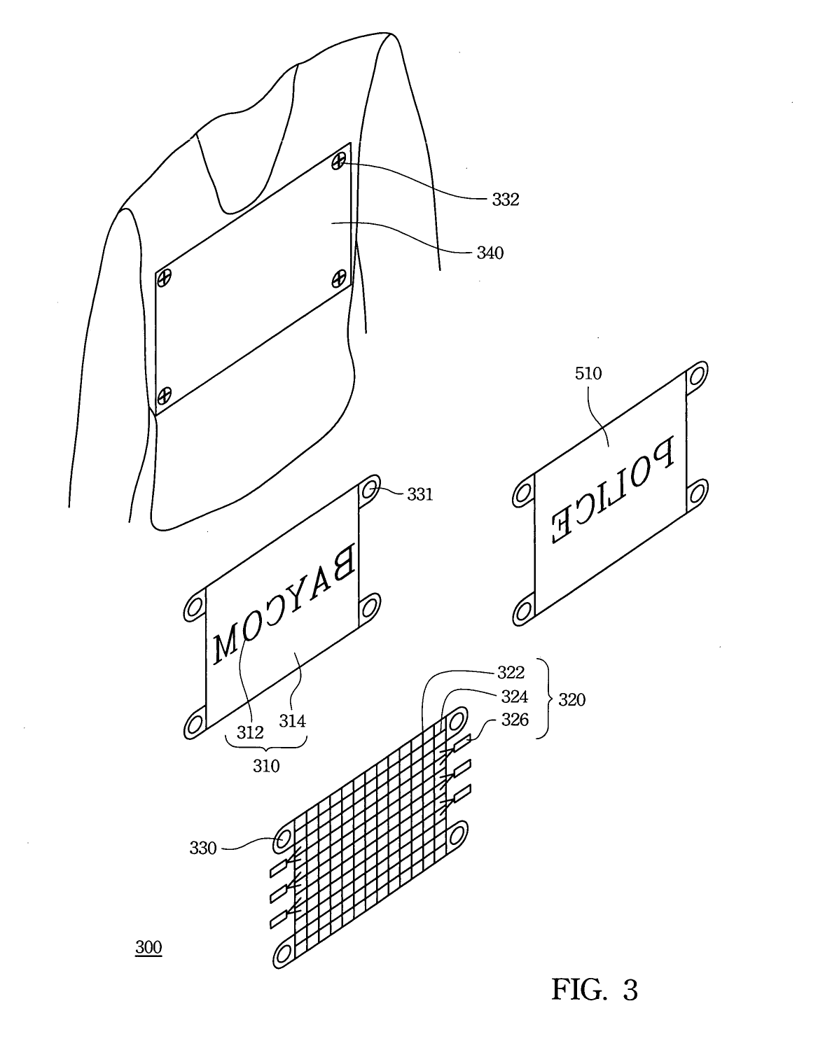

Furthermore, the arrangement between the pattern layer, the transparent layer, and the optical fabric layer can be altered to achieve different display effects. FIG. 3 illustrates an illuminating textile device according to second preferred embodiment of the present invention. In the second preferred embodiment of the present invention, the transparent layer 340 is a portion of the clothes, and is attached to the pattern layer 310 by a second fixation component 332, such as a button or Velcro.

The pattern layer 310 comprises a transparent area 312 and a non-transparent area 314, and the transparent area 312 forms the pattern to be displayed. The light generated by the optical fabric layer 320 is emitted through the transparent area 312.

The optical fabric layer 320 is woven from threads 322 and fiber optics 324. Several fiber optics 324 merge into a bundle 326, and LEDs in the bundle 326 supply light to the fiber optics 324. The bundle 326 is further connected to a switch and an AC source or a battery module, such as a dry battery or a solar battery. The optical fabric layer 320 can be attached to a corresponding attaching component 331 of the pattern layer 310 by a first fixation component 330, such as a button or Velcro.

The user can replace the pattern layer 310 with different patterns by detaching the first fixation component 330 and the corresponding attaching component 331. For example, the user can replace the pattern layer 310 with the pattern layer 510 with different patterns for achieving different display effects.

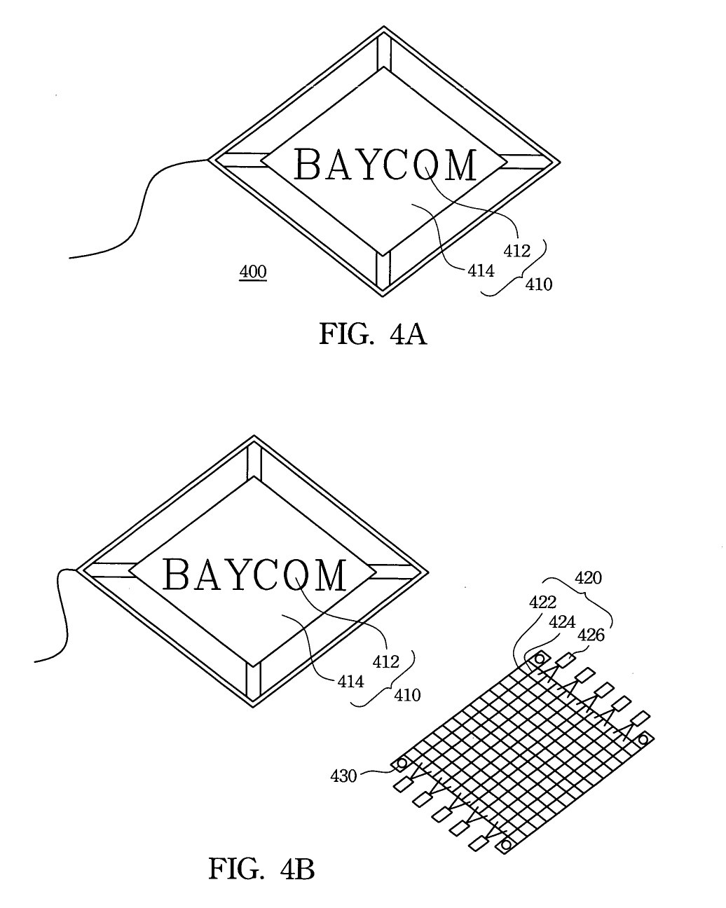

FIGS. 4A and 4B illustrate an illuminating textile device according to the third preferred embodiment of the present invention. The illuminating textile device according to the third preferred embodiment of the present invention is applied in an illuminating kite. FIG. 4A is a top view diagram of the illuminating kite 400 according to the third preferred embodiment of the present invention. The pattern layer 410 is a portion of the illuminating kite 400, and comprises a transparent area 412 and a non-transparent area 414 to form the pattern to be displayed. The light generated by the optical fabric layer 440 is emitted through the transparent area 412 for achieving the illumination effect.

FIG. 4B is an assembly diagram of the illuminating kite 400 according to the third preferred embodiment of the present invention. The kite 400 comprises a pattern layer 410 and an optical fabric layer 420. The pattern layer 410 is a portion of the illuminating kite 400 and comprises the transparent area 412 and the non-transparent area 414 to form the pattern to be displayed. The light generated by the optical fabric layer 420 is emitted though the transparent area 412.

The optical fabric layer 420 is woven from the threads 422 and the fiber optics 424. Several fiber optics 424 merge into a bundle 426 and a switch and LEDs are provided in the bundle 426 as a light source to the fiber optics 424. The bundle 426 is connected to a switch and an AC source or a battery module, such as a dry battery or a solar battery. The optical fabric layer 420 can be attached to a corresponding attaching component (not shown) of the pattern layer 410 by the first fixation component 430, such as a button or Velcro.

The illuminating textile device according to the present invention has a longer lifetime, increased illumination area, low power consumption, and high luminance. The illuminating device according to the present invention can be mass produced and employed in various applications, such as clothes, bags, kites, tents, hats, belts, toys or decorations. Further, the illuminating textile device according to the present invention has the advantages of easy replacement. The user can replace the pattern layer with desired patterns conveniently and easily.

It will be apparent to those skilled in the art that various modifications and variations can be made to the structure of the present invention without departing from the scope or spirit of the invention. In view of the foregoing, it is intended that the present invention pattern layer modifications and variations of this invention provided they fall within the scope of the following claims and their equivalents.

What is claimed is:

1. An illuminating textile device, the illuminating textile device comprising:
a pattern layer having a pattern to be displayed; and
an optical fabric layer woven from a plurality of fiber optics and a plurality of threads for providing a light source for the illuminating textile device, the optical fabric layer being attached to the pattern layer.

2. The illuminating textile device of claim 1, wherein the optical fabric layer is attached to the pattern layer by sewing.

3. The illuminating textile device of claim 1, wherein the optical fabric layer is attached to the pattern layer by a first fixation component.

4. The illuminating textile device of claim 3, wherein the first fixation component is a button or Velcro.

5. The illuminating textile device of claim 1, wherein the pattern layer is made of cloth.

6. The illuminating textile device of claim 1, wherein the pattern layer is made of plastic.

7. The illuminating textile device of claim 1, wherein the illuminating textile device is an article of clothing, a bag, a kite, a tent, a hat, a belt, a toy or a decoration.

8. The illuminating textile device of claim 1, wherein the pattern of the pattern layer is comprised of a transparent area and a non-transparent area.

9. The illuminating textile device of claim 1, wherein the optical fabric layer comprises the fiber optics and the threads in a horizontal arrangement, and the threads in a vertical arrangement.

10. The illuminating textile device of claim 1, wherein the threads are transparent yarns or reflective yarns.

11. The illuminating textile device of claim 1, wherein the fiber optics merge into a plurality of bundles, each of the bundles containing at least one LED.

12. The illuminating textile device of claim 1, wherein the optical fabric layer is powered by an AC source or a battery module.

13. The illuminating textile device of claim 12, wherein the battery module is a dry battery or a solar battery.

14. The illuminating textile device of claim 1, further comprising a transparent layer for homogenizing light emitted by the optical fabric layer.

15. The illuminating textile device of claim 14, wherein the transparent layer is between the pattern layer and the optical fabric layer.

16. The illuminating textile device of claim 14, wherein the pattern layer is between the transparent layer and the optical fabric layer.

17. The illuminating textile device of claim 14, wherein the transparent layer is a transparent film.

18. The illuminating textile device of claim 14, wherein the transparent layer is attached to the pattern layer or the optical fabric layer by sewing.

19. The illuminating textile device of claim 14, wherein the transparent layer is attached to the pattern layer or the optical fabric layer by a second fixation component.

20. The illuminating textile device of claim 19, wherein the second fixation component is a button or Velcro.
